(19) United States
(12) Patent Application Publication
(10) Pub. No.: US 2025/0296583 A1
(43) Pub. Date: Sep. 25, 2025

(54) Adaptive Control System for Nonlinear Dynamic Systems

(71) Applicant: Robert Bosch GmbH, Stuttgart (DE)

(72) Inventors: Axel Mueller, Stuttgart (DE); Michael Erden, Bietigheim-Bissingen (DE)

(21) Appl. No.: 19/082,423

(22) Filed: Mar. 18, 2025

(30) Foreign Application Priority Data
Mar. 25, 2024 (DE) 10 2024 202 834.7

(51) Int. Cl. B60W 50/06

(52) U.S. Cl. CPC B60W 50/06

(57) ABSTRACT

A method is for operating a control system for controlling a technical device of a technical system with a proportional component and at least one of a differential component and an integral component as control components. The method includes providing control parameters of a parameter set for calculating the control components depending on an operating range determined by an operating point and/or an operating state of the technical system. The method further includes controlling the technical device based on a control deviation and the control parameters. The method also includes adapting the control parameters for one or more operating ranges depending on a presence of an adaptation condition based on a control behavior within an optimization horizon associated with the adaptation condition. The optimization horizon determines a time period within which a course of the control deviation is used to adapt the control parameters.

This application claims priority under 35 U.S.C. § 119 to patent application no. DE 10 2024 202 834.7, filed on Mar. 25, 2024 in Germany, the disclosure of which is incorporated herein by reference in its entirety.

The disclosure relates to technical systems, particularly to controllers of nonlinear dynamic systems.

### BACKGROUND

Technical devices in motor vehicles, such as steering systems, traction control systems, braking systems, and the like, often require PI or PID controllers to ensure functional safety. However, these technical devices exhibit highly nonlinear and dynamic behavior. As a result, when designing the control system, the control is often configured to be operating state-dependent in that control parameters are changed based on the operating state. This typically results in a complex overall system and a very high level of application effort, as the control system must be designed separately for the different operating states. For example, in traction control, which is an example of a technical system to be controlled, the application effort is significant, and it usually takes about 18 months to complete configurations for different operating ranges. Since configuration is carried out manually, the number of control parameters and operating ranges is usually limited. As a result, system dependencies are either approximated in a greatly simplified manner or not considered, which can lead to inadequate control behavior in some operating states.

Therefore, the object of the disclosure is to provide an improved control system that independently adapts parameters for different operating ranges, wherein the parameters can also be adjusted during regular operation.

### SUMMARY

This object is achieved by the control system for a technical device, in particular in a motor vehicle, as disclosed herein, as well as by the method for operating a control system as disclosed herein.

Further embodiments are specified in the dependent claims.

According to a first aspect, a method is provided for operating a control system to control a technical device of a technical system with a proportional component and at least one of a differential component and integral component as control components, comprising the following steps:
Providing control parameters of a parameter set for calculating the control components depending on an operating range determined by an operating point and/or an operating state of the technical system;
Controlling the technical device based on a control deviation and the control parameters;
Adapting the control parameters for one or more operating ranges depending on the presence of an adaptation condition based on the control behavior within an optimization horizon associated with the adaptation condition, wherein the optimization horizon determines the time period within which the course of the control deviation is used to adapt the control parameters.

To map non-linear dynamic behavior of a technical device based on a PI, PD, or PID controller, control parameters depending on an operating range and/or operating state are often specified. The control parameters may correspond to control factors that are multiplied by the corresponding proportional, differential, and/or integral component. The control accordingly uses the control parameters specified for the operating range, and when a new operating range is determined, the control parameters are changed. The operating range is often defined in a rule-based manner, for example, by value ranges of individual operational variables or operating state variables, and a set of parameters consisting of control parameters is assigned to each of the operating ranges defined in this manner.

The parameter sets which are dependent on the operating range can be stored in a lookup or assignment table, for example, so that the control system always has access to the operating range relevant for the current operating point or operating state.

The above control system now provides for adapting one or more parameter sets if it is determined that the control quality is not sufficient within a previous time period. The control quality is determined based on a chronological course of an occurring control deviation.

With respect to this, adaptation conditions are defined that indicate when one or more of the parameter sets must be adapted.

Furthermore, a first adaptation condition may specify that an adaptation is performed when a substantial undershoot or overshoot has occurred. The substantial undershoot or overshoot is determined when the absolute control deviation is greater than a specified first deviation amount for a predetermined first time period, and the control deviation subsequently changes sign and the absolute control deviation exceeds a further deviation amount.

Furthermore, a second adaptation condition may specify that an adaptation is carried out when a control deviation exceeds a predetermined second deviation amount for more than a predetermined second time period.

Thus, if one of the adaptation conditions is detected, an optimization horizon is first determined. For the first adaptation condition, the optimization horizon corresponds to the time period between the time at which the control deviation begins to exceed the predetermined first deviation amount and the time at which the exceedance of the further deviation amount after the sign change of the control deviation is detected.

For the second adaptation condition, the optimization horizon corresponds to the time period during which the control deviation exceeds the second deviation amount, or the second time period, or a specified time period that is greater than the second time period.

The optimization horizon determines the time period within which the course of the control deviation is used to adapt the control parameters.

The control can be operated with a specified control cycle time of, for example, between 5 ms and 100 ms. The optimization horizon can be specified as a time period in ms or as a number of control cycles. For example, a control cycle time may be 20 ms and the optimization horizon may comprise two or a few up to tens of control cycles.

If an adaptation condition is met, then for each of the control parameters, i.e., the control factors Kp, Ki, and Kd, the respective contribution to the manipulated variable u is then determined in the control model in the form

$$u = Ki \int e dt + Kd de / dt + e * Kp$$

depending on the control deviation e. In particular, it is determined to what extent the proportional, differential, and/or integral components contributed to the control deviation.

For this purpose, a contribution variable B_{Kp}, B_{Ki}, B_{Kd} is determined separately for the individual control parameters Kp, Ki, and Kd as contributions for the control components, which result from the absolute sum of the corresponding term:

$${B}_{Kp} = {\sum }_{j = 1}^{N} \frac{\vert e ( j ) * Kp \vert}{\vert Ki \int e ( j ) dt \vert + \vert Kd de ( j ) / dt \vert + \vert e ( j ) * Kp \vert}$$

$${B}_{Kd} = {\sum }_{j = 1}^{N} \frac{\vert Kd de ( j ) / dt \vert}{\vert Ki \int e ( j ) dt \vert + \vert Kd de ( j ) / dt \vert + \vert e ( j ) * Kp \vert}$$

$${B}_{Ki} = {\sum }_{j = 1}^{N} \frac{\vert Ki \int e ( j ) dt \vert}{\vert Ki \int e ( j ) dt \vert + \vert Kd de ( j ) / dt \vert + \vert e ( j ) * Kp \vert}$$

wherein the integral component is determined from the start time of the optimization horizon and the time steps of the control cycles are j=1 . . . N for the optimization horizon.

For example, the contribution B_{Kp} of the proportional component to the control deviation may be the sum of the quotients formed over all time steps of the control cycles of the optimization horizon from the absolute amount of the proportional component for the time step under consideration and the sum of the absolute amounts of the proportional component, the differential component, and/or the integral component for the time step under consideration. Similarly, the contribution B_{Kd} of the differential component to the control deviation may be the sum of the quotients formed over all time steps of the control cycles of the optimization horizon from the absolute value of the differential component for the time step under consideration and the sum of the absolute values of the proportional component, the differential component, and/or the integral component for the time step under consideration. Similarly, the contribution variable B_{Ki} of the integral component to the control deviation may be the sum of the quotients formed over all time steps of the control cycles of the optimization horizon from the absolute value of the integral component for the time step under consideration and the sum of the absolute values of the proportional component, the differential component, and the integral component for the time step under consideration.

If a transition between operating ranges takes place within the optimization horizon, the contributions for the control parameters are determined separately for each operating range for the control cycles. This yields the contribution variables for the proportional, differential, and integral components for multiple operating ranges, which each form the basis for adapting the control parameters in the respective operating ranges.

The parameter sets for the control parameters for the operating ranges that occurred within the optimization horizon are thus optimized automatically based on the contribution variables of the control components. The control parameters for the corresponding operating range are now adjusted according to their assigned contribution variable at a corresponding learning rate LRp, LRd, LRi.

$$Kpneu = Kp \pm LRp * \frac{{B}_{Kp}}{{B}_{Kp} + {B}_{Ki} + {B}_{Kd}}$$

$$Kdneu = Kd \pm LRd * \frac{{B}_{Kd}}{{B}_{Kp} + {B}_{Ki} + {B}_{Kd}}$$

$$Kineu = Ki \pm LRi * \frac{{B}_{Ki}}{{B}_{Kp} + {B}_{Ki} + {B}_{Kd}}$$

The learning rates LRp, LRd, LRi may be predetermined depending on the specific operating range. In particular, the learning rate may be selected based on the control deviation. For example, the greater the squared error of the control deviation, the greater the learning rate. With a vanishingly small squared error, the learning rate will also be very low. This allows for convergence of the learning behavior (i.e., learning rate converges to 0).

Furthermore, the adjustment of the control parameters may also be weighted for the different operating ranges according to their temporal share of the optimization horizon.

The control parameters are always adjusted in such a way that they are changed in the direction that results in a manipulated variable that counteracts the control deviation. In other words, in the case of a positive control deviation, the control parameters are reduced and vice versa. In this way, if the control parameters are incorrectly adjusted, an adaptation is carried out for the corresponding operating range without the need for manual configuration.

### BRIEF DESCRIPTION OF THE DRAWINGS

Preferred embodiments are described in more detail below with reference to the accompanying drawings. The figures show:

FIG. 1 is a schematic illustration of a control system with automatic parameter adjustment for a corresponding operating range;

FIG. 2 is a flow chart illustrating a method for adjusting parameters; and

FIGS. 3a and 3b show curves of an actual value of a controller illustrating the occurrence of the first adaptation condition and the second adaptation condition, respectively.

### DETAILED DESCRIPTION

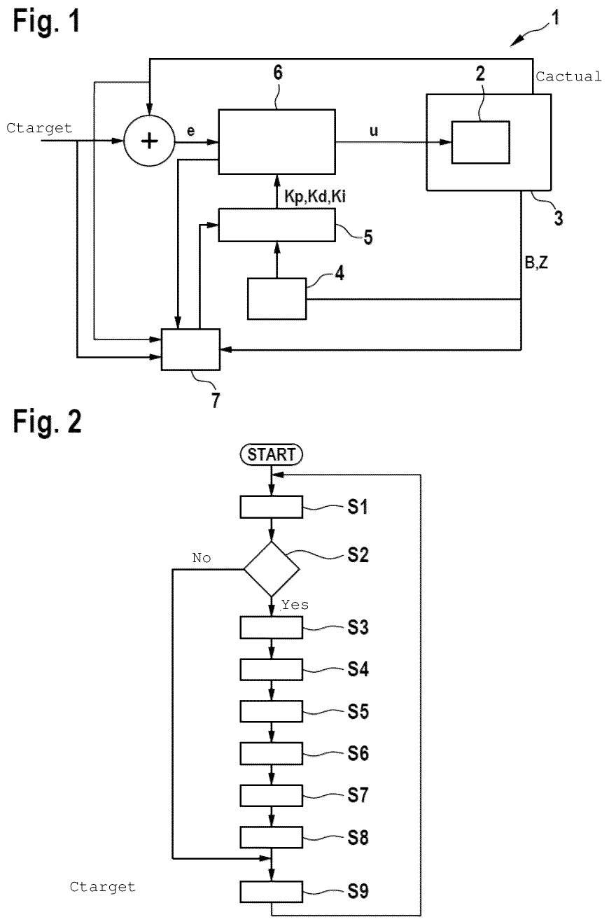

FIG. 1 shows a block diagram illustrating a control system 1 for a technical device 2 in a technical system 3, such as a vehicle. The disclosure is described below based on a vehicle's traction control.

The control system 1 comprises an operating range or operating state detection based on operational variables B and operational state variables Z. In the case of the traction control, the operational variables B may be speed, acceleration, tire temperature, and the like. Operating state variables Z may comprise weather conditions, road surface type, tire tread, ambient temperature, and the like. The operational variables B and operating state variables Z can be sensed or determined based on a model. By partitioning the operational variables and the operating state variables into regions, different operating ranges can be identified and defined in an operating range block 4, for which a set of parameters is to be determined or adapted.

In a parameter set selection block 5, a lookup table or an assignment table is used to assign a particular set of control parameters Kp, Kd, Ki (Kp as proportional factor, Kd as differential factor, Ki as integrator factor, i.e., integration factor), which may be defined separately for each operating range, to the identified operating range in which the technical system 3 is currently located. The parameter set is supplied to a controller 6, which may be embodied as PD, PI or PID controller.

The controller obtains a control deviation e between a target specification Ctarget and an actual value Cactual, which may also correspond to an operational variable. For example, the control deviation may correspond in the form of a speed difference between the vehicle speed and the speed of a drive wheel.

From the control deviation e, the controller 6 generates a manipulated variable u:

$$u = Ki \int e dt + Kd de / dt + e * Kp$$

The controller can also be designed as a differential controller, wherein the control deviation e then corresponds to the differential component.

The manipulated variable u output by the controller 6 may correspond to a requested engine torque in order to enable an optimal slippage, i.e. an optimal deviation between the wheel speed and the vehicle speed, according to the target specification Ctarget. The parameter set selection block 5 allows the appropriate parameter set to be selected depending on the detected operating state. The parameter sets can now be adapted according to the quality of the controller.

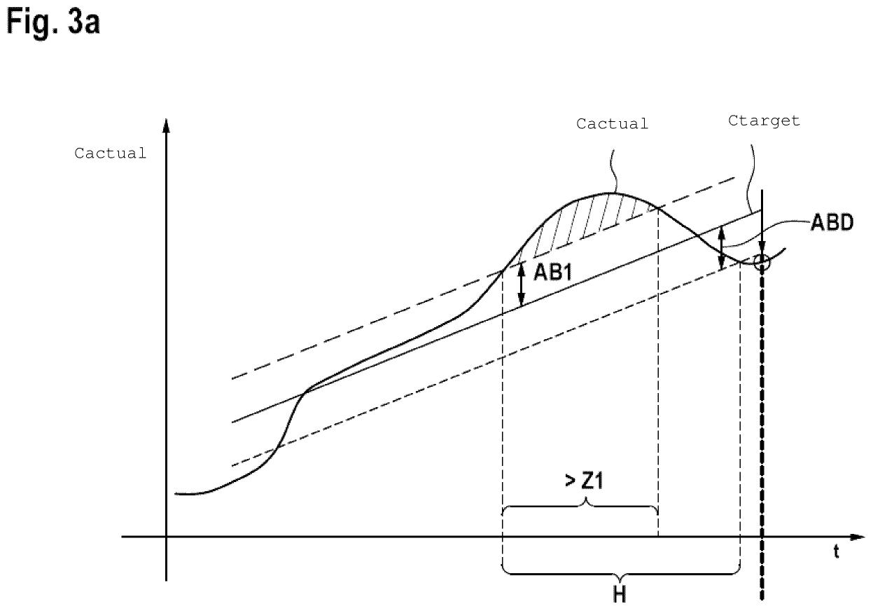

In an adaptation block 7, control parameters are adapted depending on the operating range and updated in the parameter set selection block 5. In the adaptation block 7, a method is performed as described in more detail in the flow chart of FIG. 2.

The control deviation e is determined in step S1, then in step S2 a check is carried out to determine whether an adaptation condition exists. The control deviations e are therefore temporarily stored, and a time course of the control deviation is analyzed.

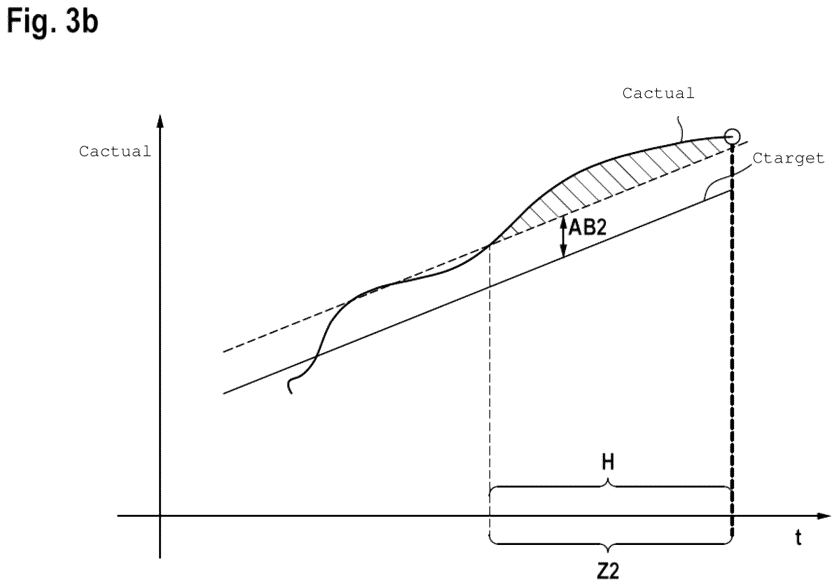

A first adaptation condition may exist if, as shown in FIG. 3a, the control deviation e is greater than a predetermined first deviation amount AB1 over a predetermined first time period Z1, and subsequently the sign of the control deviation e changes and a further deviation amount ABD is exceeded within a predetermined further shorter time period.

Alternatively or additionally, a second adaptation condition may be detected if, as shown in FIG. 3b by way of example, a control deviation e is above a second predetermined deviation amount AB2 for a second predetermined time period Z2.

Alternatively or additionally, other criteria for adaptation conditions may also be defined.

If an adaptation condition is met (alternative: Yes), the method continues with step S3; otherwise (alternative: No), it jumps to step S10.

In step S3, an optimization horizon H is determined. For the first adaptation condition, the optimization horizon H begins at the time when the absolute control deviation e exceeds the predetermined first deviation amount AB1 and ends at the time when the absolute control deviation e exceeds the predetermined further deviation amount ABD with an inverted sign. For the second adaptation condition, the optimization horizon H begins at the time when the absolute control deviation e exceeds the predetermined second deviation amount AB2 and ends at the time when the control deviation e falls below the second deviation amount AB2 once again or after the second predetermined time period Z2.

In a subsequent step S4, control components Ki∫e dt,

$$Kd \frac{de}{dt}$$

e*Kp for each time step t are calculated for the control deviations within the optimization horizon H, wherein the control parameters Kp, Kd, Ki are assumed for the operating range determined at each time step.

In a subsequent step S5, contributions of the individual control components, i.e. the share of the differential component, the integral component and the proportional component in the total manipulated variable u determined for the relevant control cycle j, are now examined for each of the control cycles within the optimization horizon j=1 . . . N. For this purpose, the contributions of the individual shares for the control cycle are calculated as follows:

$$\frac{\vert e ( j ) * Kp \vert}{\vert Ki \int e ( j ) dt \vert + \vert Kd \frac{de ( j )}{dt} \vert + \vert e ( j ) * Kp \vert}$$

$$\frac{\vert Kd \frac{de ( j )}{dt} \vert}{\vert Ki \int e ( j ) dt \vert + \vert Kd \frac{de ( j )}{dt} \vert + \vert e ( j ) * Kp \vert}$$

$$\frac{\vert Ki \int e ( j ) dt \vert}{\vert Ki \int e ( j ) dt \vert + \vert Kd \frac{de ( j )}{dt} \vert + \vert e ( j ) * Kp \vert}$$

wherein in each control cycle the control parameters are assumed that arise from the respective operating range or operating state range.

$${B}_{Kp} = {\sum }_{j = 1}^{N} \frac{\vert e ( j ) * Kp \vert}{\vert Ki \int e ( j ) dt \vert + \vert Kd de ( j ) / dt \vert + \vert e ( j ) * Kp \vert}$$

$${B}_{Kd} = {\sum }_{j = 1}^{N} \frac{\vert Kd de ( j ) / dt \vert}{\vert Ki \int e ( j ) dt \vert + \vert Kd de ( j ) / dt \vert + \vert e ( j ) * Kp \vert}$$

$${B}_{Ki} = {\sum }_{j = 1}^{N} \frac{\vert Ki \int e ( j ) dt \vert}{\vert Ki \int e ( j ) dt \vert + \vert Kd de ( j ) / dt \vert + \vert e ( j ) * Kp \vert}$$

By summing up the individual contributions of the controller components of the control cycles, it is possible to determine which controller component, i.e. the proportional component, the differential component and/or the integral component, makes the largest contribution to determining the manipulated variable u for a specific operating range within the optimization horizon H. Values are always summed up only for the control cycles to which the same operating range is assigned. For multiple operating ranges within an optimization horizon H, the contributions of the controller components are calculated and evaluated separately.

The manipulated variable u results in the actual value Cactual, which is compared with the target specification Ctarget. In the case of the traction control, the target specification and the actual specification may correspond to a target drive torque or a target speed or an actual drive torque or an actual speed. To adjust the parameter sets assigned to the operating ranges, the ratio of the contributions for the proportional component, the differential component and the integral component, respectively,

$$\frac{{B}_{Kp}}{{B}_{Kp} + {B}_{Ki} + {B}_{Kd}}$$

$$\frac{{B}_{Kd}}{{B}_{Kp} + {B}_{Ki} + {B}_{Kd}}$$

$$\frac{{B}_{Ki}}{{B}_{Kp} + {B}_{Ki} + {B}_{Kd}}$$

in the sum of the contributions can be assumed as the contribution share in step S6 for each time period within the optimization horizon H which is assigned to a specific operating range, wherein the control parameters of the parameter sets for the relevant operating range that occurred during the time period within the optimization horizon H are adapted automatically as a function of the contribution share of the relevant control component.

The control parameters for the corresponding operating range are now adjusted to the control parameters Kp_neu, Kd_neu, Ki_neu in step S7 according to their assigned contribution variable at a corresponding learning rate LRp, LRd, LRi.

$$Kp\_neu = Kp \pm LRp * \frac{{B}_{Kp}}{{B}_{Kp} + {B}_{Ki} + {B}_{Kd}}$$

$$Kd\_neu = Kd \pm LRd * \frac{{B}_{Kd}}{{B}_{Kp} + {B}_{Ki} + {B}_{Kd}}$$

$$Ki\_neu = Ki \pm LRi * \frac{{B}_{Ki}}{{B}_{Kp} + {B}_{Ki} + {B}_{Kd}}$$

The learning rates LRp, LRd, LRi may be specified depending on the respective operating range. Alternatively, the learning rate may be selected based on a control deviation.

Based on the contribution shares, the parameter sets for the time periods of the operating ranges within the optimization horizon H are thus adjusted, wherein the adjustment is carried out in such a way that the manipulated variable u is increased or decreased to counteract the control deviation e. In other words, if the control deviation is negative for the traction control, the manipulated variable of the torque is increased by increasing the corresponding control factors. Conversely, the control factors are reduced when the control deviation is positive.

In step S8, the adjusted control parameters are saved back into the parameter set selection block 5 depending on the operating range.

In step S9, a manipulated variable u is determined by summing up the control components in accordance with the control 6.

Then, the process returns to step S1.

What is claimed is:

1. A partially computer-implemented method for operating a control system to control a technical device of a technical system with a proportional component and at least one of a differential component and an integral component as control components, the method comprising:
providing control parameters of a parameter set for calculating the control components depending on an operating range determined by an operating point and/or an operating state of the technical system;
controlling the technical device based on a control deviation and the control parameters; and
adapting the control parameters for one or more operating ranges based on a presence of an adaptation condition based on a control behavior within an optimization horizon associated with the adaptation condition,
wherein the optimization horizon determines a time period within which a course of the control deviation is used to adapt the control parameters.

2. The method according to claim 1, wherein:
a first adaptation condition provides that an adaptation is carried out when a substantial undershoot or overshoot has occurred,
the substantial undershoot or overshoot is determined when an absolute control deviation is greater than a specified first deviation amount for a predetermined first time period and the control deviation subsequently changes sign and the absolute control deviation exceeds a further deviation amount, and
the associated optimization horizon corresponds to a time period between a time when the control deviation starts to exceed the predetermined first deviation amount and a time when the further deviation amount is exceeded after the sign change of the control deviation.

3. The method according to claim 1, wherein:
a second adaptation condition provides that an adaptation is performed when a control deviation is above a predetermined second deviation amount for more than a predetermined second time period, and
the optimization horizon for the second adaptation condition corresponds to a time period during which the control deviation exceeds the second deviation amount or the second time period.

4. The method according to claim 1, wherein within one or more time periods within the optimization horizon, each associated with an operating range, contribution shares of each of the control components are determined that define a degree of adaptation of the control parameters to be adapted.

5. The method according to claim 4, wherein for individual control parameters, a contribution for the control components is determined, which results from an absolute sum of a quotient, formed over all time steps of control cycles of the optimization horizon attributable to a corresponding operating range, of an absolute value of a corresponding control component for a considered time step and a sum of the absolute values of all control components.

6. The method according to claim 5, wherein the adaptation of the parameter sets of the control parameters for the operating ranges that have occurred within the optimization horizon is carried out for each control parameter depending on a proportion of the respective contribution to a sum of the contributions.

7. The method according to claim 6, wherein:
the adaptation is based on a respective learning rate, and
a weighting of an adjustment of the control parameters is carried out for different operating ranges according to a temporal proportion of the associated time period in the optimization horizon.

8. The method according to claim 7, wherein the adaptation of the control parameters is carried out by changing the control parameters in a direction that produces a manipulated variable that counteracts the control deviation.

9. The method according to claim 1, further comprising:
operating a traction control system,
wherein the control deviation indicates a difference between a target speed and an actual speed, or a difference between a specified target torque and an actual torque of a drive motor.

10. A device for performing the method according to claim 1.

11. The method according to claim 1, wherein a computer program product comprises instructions which, when executed by at least one data processing device, cause the data processing device to perform the method.

12. A non-transitory machine-readable storage medium comprising instructions which, when executed by at least one data processing device, cause the data processing device to perform the method according to claim 1.
